(19) United States
(12) Patent Application Publication
(10) Pub. No.: US 2005/0224412 A1
(43) Pub. Date: Oct. 13, 2005

(54) Water treatment system having upstream control of filtrate flowrate and method for operating same

(76) Inventors: Graham J. Best, Guelph (CA); Nicholas William Harcsar Adams, Hamilton (CA); Pierre Lucien Cote, Dundas (CA); Daniel Richard Zabarylo, Oakville (CA)

Correspondence Address: BERESKIN AND PARR, 40 KING STREET WEST, BOX 401, TORONTO, ON, M5H 3Y2, CA

(21) Appl. No.: 11/101,486

(22) Filed: Apr. 8, 2005

Related U.S. Application Data
(60) Provisional application No. 60/560,614, filed on Apr. 9, 2004.
(60) Provisional application No. 60/585,077, filed on Jul. 6, 2004.

(51) Int. Cl. B01D 61/20

(52) U.S. Cl. 210/637; 210/650; 210/137; 210/321.65

(57) ABSTRACT

A method for treating water with a membrane filtration unit provides a generally constant filtrate flowrate from one or more membrane filtration units by varying the pressure on the upstream or feed side of the unit(s) as required by changes in the permeability of the (units).

This is an application claiming the benefit under 35 USC 119(e) of U.S. Application Ser. Nos. 60/560,614, filed Apr. 9, 2004, and 60/585,077, filed Jul. 6, 2004. Application Ser. Nos. 60/560,614 and 60/585,077 are incorporated herein, in their entirety, by this reference to them.

### FIELD OF THE INVENTION

The present invention relates to water treatment, and more particularly to water treatment using immersed filtering membranes.

### BACKGROUND OF THE INVENTION

Membrane systems consist of one or more membrane filtration units which may be connected together in parallel. It is desirable to have a substantially constant filtrate flowrate overall and the same filtrate flowrate from each membrane filtration unit. However, the filtrate flowrate from a membrane filtration unit under a constant suction can vary depending on the state of fouling of the membranes. Moreover, similar membrane filtration units do not necessarily become fouled at the same rate.

Accordingly, in some systems, each membrane filtration unit has a dedicated flowrate meter and filtrate pump with a variable frequency drive (VFD) controller as required to produce a constant flow. In another system, several membrane filtration units are connected to a common suction source but each filtration unit has a dedicated flow meter and a control valve in its filtrate line. The control valves are modulated such that each filtration unit produces the desired flow rate.

### SUMMARY OF THE INVENTION

It is an object of the present invention to improve on the prior art. Other objects of the invention include providing a water treatment method or apparatus, for example, a method or system that provides a generally constant overall filtrate flowrate or a flowrate that is generally constant between plural filtration units. The one or more inventions consist of combinations of one or more of the elements or steps described in this document. The summary below discusses various features of the one or more inventions that may help the reader understand the one or more inventions, but is not intended to define any invention.

The inventors have noticed that, while it is desirable to have an overall constant filtrate flowrate from a membrane system and similar flow rates between parallel filtration units, having sensors and controlled devices on the downstream or filtrate (permeate) side of each membrane filtration unit increases the capital cost and complexity of the system. In some systems, such as those using downstream valves, parasitic head losses are also created. In the present invention, however, the filtrate flowrate for each membrane filtration unit is controlled on the upstream or feed side of the membrane filtration units without downstream sensors and controlled devices and optionally with automatic equalization of filtrate flowrates between parallel units.

In general terms, a generally constant feed water flowrate, or feed water flowrate less retentate flowrate if there is any retentate removal during permeation, is provided to each membrane filtration unit. A filtrate is withdrawn from each membrane filtration unit by applying a generally constant suction to each membrane filtration unit. After commencing operation of the system, a generally constant equilibrium filtrate flowrate is established for each membrane filtration unit although the permeability of the membranes decreases over time (due to membrane fouling and/or an increase in the viscosity of the feed water). In order to maintain a generally constant flux across the membranes for each membrane filtration unit, the pressure on the upstream or feed side of each membrane unit is automatically increased as required. This increase in upstream pressure is accomplished by continuing to supply feed water at a rate equal to the desired filtrate flowrate and allowing the liquid head, or depth of water, above the membrane filtration units to increase as required until the liquid head provides enough pressure to provide the desired filtrate flowrate. The maintenance of a generally constant flux across the membranes for each membrane unit results in a generally constant filtrate flowrate from each membrane filtration unit. The available tank freeboard above each membrane filtration unit is designed to allow for a maximum liquid head calculated based on a “worst case” scenario (i.e., the lowest permeability of the membrane that occurs at the highest feed water viscosity and the highest permitted membrane resistance or fouling). Similarly, the system is designed, primarily by not making the suction on the filtrate side of the membranes too strong, such that flux under the best anticipated conditions does not result in the water level dropping below the highest part of the membranes during ordinary permeation.

The flowrate of feed water into each unit is independent of the water level in the unit and, if there are multiple units, is split generally evenly between those units regardless of the current water level in each unit. In this way, each unit receives feed water at generally the same rate. Retentate is either not removed during permeation or removed at a generally equal rate between the units. In this way, the rate of feed flow, which is easily made generally constant in time or between parallel filtration units, controls the flow of filtrate through the filtration units. In particular, as a filtration unit fouls, the water level in the unit rises resulting in an increase in transmembrane pressure. The tank water level rises until the flowrate of filtrate generally equals the flow rate before the filtration unit fouled. With the feed flow split generally evenly between parallel filtration units, each unit will produce generally the same filtrate flow rate, even if the area of the membranes varies between the units as long as the system remains within design limits, such as minimum or maximum transmembrane pressure or water level. However, if the membrane area in the filtration units is the same, then all membranes will also operate at generally the same flux. This is generally desirable, since it allows for a common design of each filtration unit, although the common unit design may allow for small variations in membrane area, for example as caused by loss of some membrane due to repair procedures. The invention can also be applied to a system consisting of a single unit to produce a generally constant filtrate flow over time from that unit. Fluxes, flow rates and similar measurements may be considered to be generally constant or generally the same if the variance, for example in time or between units, is less than 15% or 10% when averaged over a short period of time, for example an hour, under normal operation, that is accounting for, or measuring at a time between, periodic interruptions to regular permeate flow caused by disturbances such as backwashing, deconcentrating or maintenance procedures.

### BRIEF DESCRIPTION OF THE DRAWINGS

For a better understanding of the present invention, and to show more clearly how it may be carried into effect, reference will now be made, by way of example, to the accompanying drawing, which shows an exemplary embodiment of the present invention and in which:

FIG. 1 is a schematic diagram of a water treatment system according to an embodiment of the present invention.

### DETAILED DESCRIPTION OF EMBODIMENT(S)

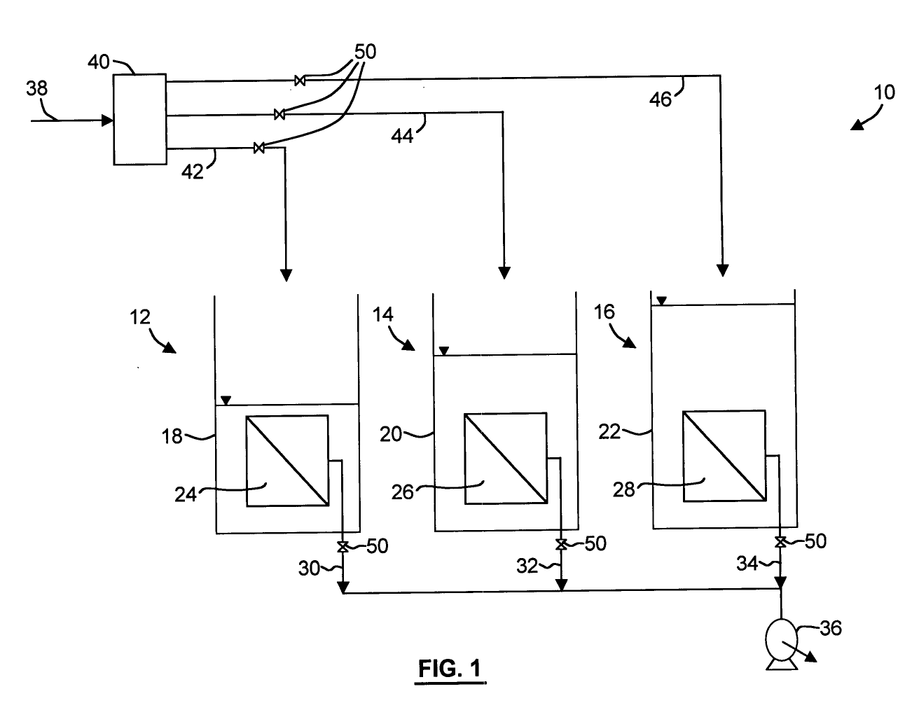

Referring first to FIG. 1, a water treatment system according to an embodiment of the present invention is shown generally at 10. The water treatment system 10 has, in the embodiment illustrated, three membrane filtration units 12, 14, 16 although there may be other numbers of filtration units, for example between 1 and 10. Untreated feed water flows through a main feed water line 38 towards a flow regulating means 40, for example, a series of weirs of the same shape and elevation on the down-stream edge of a splitter box, to ensure a generally constant flowrate of untreated feed water to each membrane filtration unit 12, 14, 16 through separate feed lines 42, 44, 46, respectively. Each filtration unit 12, 14, 16 has a tank 18, 20, 22 and one or more membrane modules 24, 26, 28, respectively. Filtrate (filtered water or permeate) is removed from each membrane module 24, 26, 28 through separate filtrate lines 30, 32, 34, respectively, which may be connected to a source of suction, which in the embodiment illustrated, is a filtrate pump 36 running at a generally constant speed.

Each membrane module 24, 26, 28 may be an immersed suction driven membrane module. Each membrane module 24, 26, 28 may have pores that are sized for ultra-filtration or micro-filtration. For example an immersed hollow fiber membrane such as those sold under the trade mark ZEEWEED™ by Zenon Environmental Inc., such as ZW1000™ or ZW500™ modules, may be used. Suitable modules are also described in U.S. Pat. Nos. 5,639,373 and 6,325,928, which are fully incorporated herein by this reference to them. The membrane walls divide the module into an “upstream side”, “feed side” or “tank side” and a “non-feed side”, “filtrate side” or “permeate side”.

“Transmembrane pressure (differential)” as used herein refers to the pressure difference across a membrane wall resulting from the pressure on the feed side and suction on the filtrate (permeate) side. The source of suction must be sufficient to provide an adequate transmembrane pressure differential to drive the desired flow of liquid across the membrane wall under all permitted process conditions, particularly water level in the tank, membrane permeability and water viscosity. The relationship of flux to permeability and transmembrane pressure differential is set forth in the following equation:
J=kΔP(1)
wherein J=flux; k=permeability; ΔP=transmembrane pressure differential; and k=1/μRm where μ=viscosity of water and Rm=membrane resistance. The degree of fouling of the membranes effects Rm. Water temperature effects μ and Rm.

The suction can be generated with a conventional pump if the required suction is sufficiently low, for example in the range from about 0.7 kPa (0.1 psi) to about 101 kPa (1 bar). Required suction can be kept low with reasonable filtrate flow providing an adequate liquid head at all times between the surface of the feed water and the membrane modules 24, 26, 28. In this way, a non-vacuum pump can provide an adequate net positive suction head (NPSH) to provide the maximum required transmembrane pressure differential that will be generated under the design operating conditions. A non-vacuum pump may be a centrifugal, rotary, crossflow, flow-through, or other type known in the art. Moreover, once a vacuum pump induces the filtrate flow, the pump may not be necessary, the filtrate continuing to flow under a siphoning effect, preferably exiting into air or into a well of generally constant water surface elevation so that the suction remains generally constant. Further alternately, a system may be configured so that a siphon can be created by gravity flow through a pipe without requiring a pump to start the flow. These concepts are more fully described in U.S. Pat. No. 5,248,424, which is fully incorporated herein by this reference to it.

Still referring to FIG. 1, untreated feed water is introduced into a fluid regulating means 40 through line 38. The fluid regulating means 40 ensures a constant feed water flowrate to each membrane filtration unit 12, 14, 16, through feed water lines 42, 44, 46, respectively. Alternately, multiple independent feed lines can be used. A constant suction on the inner surface of the membranes in the membrane filtration modules 24, 26, 28 draws filtrate through the membrane wall. The filtrate is removed from the membrane filtration modules 24, 26, 28 through filtrate lines 30, 32, 34, respectively. Contaminants are rejected by the membrane filtration modules 24, 26, 28 and accumulate in the tank water and may be removed through a retentate drain (not shown), pumped out from time to time or digested. Rates of retentate removal, averaged over time, are preferably generally equal between the filtration units 12, 14, 16 and may be compensated for by changes to the flow of feed 38 if retentate removal occurs during permeation. However, in a batch process, retentate removal occurs while permeation is stopped and does not effect flow of feed 38 during permeation. The membrane filtration modules 24, 26, 28 may be air scoured to reduce fouling on the surface of the membranes as desired.

As stated above, the flux across a membrane (J)=permeability (k or 1/μRm) x transmembrane pressure (ΔP). The flux across the membranes multiplied by their area gives the total filtrate flow rate. Over time, the membranes in the membrane modules 24, 26, 28 become fouled (increase in Rₘ) and the viscosity (μ) of the feed water may increase. This results in a decrease in the permeability (k) of each membrane filtration module 24, 26, 28. The present invention provides for a generally constant flux (J) across each membrane irrespective of state of fouling of the membrane (Rₘ) and the viscosity (μ) of the feed water. A generally constant flux (J) across each membrane results in a generally constant filtrate flowrate from each membrane filtration unit 12, 14, 16. The present invention provides for an automatic corrective increase in the transmembrane pressure (ΔP) by increasing pressure on the upstream or feed side of each membrane filtration module 24, 26, 28 to compensate for this decrease in permeability (k) which in turn preserves a generally constant filtrate flowrate from each membrane filtration module 24, 26, 28. This is accomplished by providing a generally constant feed water flowrate and allowing the liquid head for each membrane filtration module 24, 26, 28 to increase (or decrease) as required until the filtrate flowrate is equal to the feed water flowrate, less the rate at which retentate is removed during permeation, if any. “Liquid head” as used herein is measured as the vertical distance between the surface of the feed water in the tank and the level from which permeate is withdrawn from the tank. In this way, a generally constant filtrate flowrate can be maintained from each membrane filtration module 24, 26, 28. Moreover, membrane filtration modules do not necessary become fouled at a constant rate. However, the present invention provides a liquid head that varies between filtration units 12, 14, 16 to compensate for fouling at various rates and produce a generally constant and equal filtrate flowrate for each unit. If the filtration modules 24, 26, 28 each have the same surface area of membrane, then there will also be a generally constant and equal filtrate flux from the membranes of each unit 12, 14, 16. The generally constant filtrate flowrate that is maintained is generally equal to the filtrate flowrate that is initially obtained after commencing the operation of the method. The present invention also permits independent control of each membrane filtration unit 12, 14, 16 as required. For example, each membrane filtration module 24, 26, 28 can be cleaned, or each unit 12, 14, 16 deconcentrated in a batch process when it reaches the maximum permitted liquid head without simultaneously cleaning the other filtration modules 24, 26, 28 or deconcentrating the other units 12, 14, 16.

Backwashing may be performed, in a batch process, after permeation stops for retentate to be removed and before the tank is refilled with feed, and permeation resumed. In this way, backwashing does not effect filtrate flows. If backwashing is desired in a continuous process or between retentate removal or deconcentration steps in a batch process, backwash volumes, averaged over time, may be made equal between the filtration units 12, 14, 16 and the rate of flow of feed 38 may be modified to account for the backwashing flow or simply absorbed by a temporary increase in water level and filtrate flow rate.

The filtration units 12, 14, 16 can be deconcentrated, backwashed or otherwise cleaned all at the same time or individually. If cleaned individually, a particular unit 12, 14, 16 can be isolated by closing its associated isolation valves 50 if required. While one unit 12, 14, 16 is isolated, flow of feed 38 may be correspondingly reduced or merely diverted to the non-isolated units 12, 14, 16 temporarily. Temporary disruptions to the filtrate flow from these or other maintenance or cleaning procedures are not considered to detract from the generally constant (in time) or equal (between units 12, 14, 16) filtrate flows provided by the invention. It is sufficient if the generally constant or equal filtrate flows are provided between these cleaning or maintenance events or when averaged over a period of time of sufficient length to reduce the numerical effect of such events or to include an equal number of the maintenance or cleaning events in each of the one or more units 12, 14, 16 in the system 10.

It is to be understood that what has been described are preferred embodiments of the invention for example and without limitation to the combination of features necessary for carrying the invention into effect. The invention may be susceptible to certain changes and alternative embodiments without departing from the subject invention, the scope of which is defined in the following claims.

1. A method for treating water in a water treatment system having at least one membrane filtration module in at least one membrane filtration unit, comprising:
a) providing a generally constant feed water flowrate to the at least one membrane filtration unit;
b) withdrawing a filtrate from the at least one membrane filtration module by applying a generally constant suction on the permeate side of the at least one membrane filtration module; and
c) maintaining a generally constant filtrate flowrate from the at least one membrane filtration unit by increasing the pressure on the feed side of the at least one membrane filtration module as the permeability across the at least one membrane filtration module decreases over time.

2. A method according to claim 1, wherein the pressure on the feed side of the at least one membrane filtration module is increased by increasing the liquid head above the at least one membrane filtration module.

3. A method according to claim 1, wherein the generally constant filtrate flowrate in step (c) is substantially equal to a filtrate flowrate that is initially obtained after commencing operation of the method.

4. A method according to claim 1, wherein withdrawing the filtrate from the at least one membrane filtration module in step (b) includes using a suction induced by gravity flow or a siphon.

5. A method according to claim 1, wherein withdrawing the filtrate from the at least one membrane filtration module in step (b) includes using a suction induced by a filtrate pump.

6. A method according to claim 1, wherein the water treatment system has a plurality of membrane filtration units and steps (a)-(c) are simultaneously performed on each of the membrane filtration units.

7. A method according to claim 2 wherein the liquid head above the at least one membrane filtration unit module is increased by providing a feed water flowrate into the at least one membrane filtration unit that is at least as large as the generally constant filtrate flowrate.

8. An apparatus for producing a filtrate comprising:
a) a tank;
b) a membrane module in the tank having a feed side and a permeate side;
c) a feed supply providing a generally constant flowrate of feed water for the tank; and,
d) a source of a generally constant suction connected to a permeate side of the membrane module.

9. An apparatus for producing a filtrate comprising a plurality of the apparatus of claim 8 wherein the feed flowrate and suction for each is generally the same.

10. The apparatus of claim 9 wherein the permeate sides of each of the apparatus of claim 8 are attached to the same source of suction.

11. The apparatus of claim 9 wherein the feed supplies of each of the apparatus of claim 8 are attached to a flow regulator means that divides a common feed flow into a number of generally equal feed flows, one for each apparatus of claim 8.

12. The apparatus of claim 11 wherein the flow regulator is a splitter box having a series of weirs of similar shape and elevation.
